(19) United States
(12) Patent Application Publication
(10) Pub. No.: US 2005/0288086 A1
(43) Pub. Date: Dec. 29, 2005

(54) Hand count methods and systems for casino table games

(75) Inventors: Oliver M. Schubert, Las Vegas, NV (US); Atilla Grauzer, Las Vegas, NV (US); Justin G. Downs III, Henderson, NV (US); James V. Kelly, Las Vegas, NV (US); James R. Roberts, North Las Vegas, NV (US)

Correspondence Address: Mark A. Litman & Associates, P.A., York Business Center, Suite 205, 3209 West 76th St., Edina, MN, 55435, US

(73) Assignee: Shuffle Master, Inc.

(21) Appl. No.: 10/957,877

(22) Filed: Oct. 4, 2004

Related U.S. Application Data
(63) Continuation-in-part of application No. 10/880,410, filed on Jun. 28, 2004.
(63) Continuation-in-part of application No. 10/880,408, filed on Jun. 28, 2004.

(51) Int. Cl. G06F 19/00; G06F 17/00

(52) U.S. Cl. 463/11

(57) ABSTRACT

A gaming table with multiple sensing devices on or proximate the table. Each sensing device or groups of devices has a separate intelligent module that senses changes in the sensing devices, as through a state change signal from the sensor. The module date stamps and transmits the data over a network to an external database. The modules broadcast information over a network, such as an Ethernet.

### RELATED APPLICATIONS

This application is a Continuation-In-Part of both co-pending applications, Ser. No. 10/880,410 and Ser. No. 10/880,408, both filed Jun. 28, 2004.

### BACKGROUND OF THE INVENTION

1. Field of the Invention

The present invention relates to the field of gaming systems, particularly to table gaming systems that have elements of play, reward, monetary/credit transactions and/or monitoring that are performed by processing systems, and particularly including casino table games and casino table card games.

2. Background of the Art

Wagering games, such as those played in casinos and card clubs, have traditionally been played with only live casino personnel (dealers, croupiers, etc.) and mechanical or physical implements such as cards, dice, chips, jettons, markers, wheels, balls and the like. One of the reasons for this is to make the entire wagering game open for inspection, including the players, the casino personnel and the implements that are used to provide the chance occurrences upon which the wagers are made.

The creative minds of players and wagering institutions have devised ways of manipulating implements or calculating probabilities of events that have affected the odds in the favor of the manipulator. Cards have been marked, ‘sleeved’ for timed use, stacked in a deal, bottom dealt, or otherwise altered in characteristics or location to enable cheating. Sophisticated players are able to read decks by counting cards, and have been able to calculate changes in the probability of success at different times in the game of blackjack in particular, altering overall odds more in favor of the player. The use of limited portions of decks, efficient card shuffling devices, restrictions on players' handling of cards, and continuous shuffling devices have alleviated some of the card game problems.

Dice have been weighted or counterfeited to influence the occurrence of specific values, chips have been switched or amounts altered on the tables in craps. This has been addressed by the presence of many persons in the pit crew that supervise elements of the game and the close surveillance of activities on the table by pit personnel at the table or supervisory personnel watching cameras or tapes of activities.

Processing equipment and computers have become an increasingly important part of the gaming industry, but the introduction of the technology has been sporadic, inconsistent, and often ill designed. In addition, the direction of improvement in the processing apparatus used in casinos has consistently been heading in the direction that bigger and more powerful is better, attempting to mimic the home computer market trends. The original processors used in slot machines, for example, were hardwired, unique designs that performed all command functions from a central controlling processor or and that sent signals to all mechanical operating elements.

Traditional gaming devices such as slot machines, for example are based around a simple processor unit including a random number generator, an accounting means operatively coupled to a static/battery backed random access memory, and a set of EPROM's and PROMS having stored therein the important gaming functions. In addition, these gaming devices include gaming displays, coin acceptors, bill validators and hoppers, all operatively coupled to the same processor. These gaming devices are relatively simple and are limited in scope, usually consisting of a single executing program utilizing straightforward interrupt schemes and detection loops for simple evaluation. It is also a simple matter of operatively coupling an external program validation device to an EPROM chip for providing effective regulatory validation of critical gaming functions to preclude unauthorized tampering or modification of the gaming machine through software. In addition, an external device validation process for suspicious jackpots or disputes may be validated by simply reading the static/battery backed random access memory associated with the simple processor. Furthermore, software developers in the gaming industry are hesitant to include compromising code in traditional gaming devices due to the ease of both internal and regulatory review.

One important trend in today's gaming devices is towards an increasing utilization of personal computer based gaming platforms. Personal computer based platforms are being employed by designers to make use of real time operating systems which allow for multi-threaded/multi-tasking processes and the use of many “off the shelf” hardware and software components. While at first, this may seem an advantage at least from a manufacturing standpoint, it creates design obstacles in an environment requiring high security and regulatory monitoring. Designs of this nature elude validation by regulatory authorities in two areas, initial laboratory evaluation and field validation.

There are a wide variety of associated devices that can be connected to or serve as part of a gaming machine such as a slot machine. These devices provide gaming features that define or augment the game(s) played on the gaming machine. Some examples of these devices are slot reels, lights, ticket printers, card readers, speakers, bill validators, coin acceptors, display panels, keypads, and button pads. Many of these devices are built into the gaming machine. Often, a number of devices are grouped together in a separate box that is placed on top of the gaming machine. Devices of this type are commonly called a top box.

Published U.S. Patent Application Serial No. 2002/0107067 A1 (McGlone et al.) provides a slot reel peripheral having a slot reel, a drive mechanism and a peripheral controller. Using a standard communication protocol such as USB (Universal Serial Bus), the peripheral controller is configured to communicate with one or more master gaming controllers or other slot reel peripherals via a peripheral connection. The peripheral controller may drive the slot reel from position to position by operating the drive mechanism and may send operating instructions to other slot reel peripherals with peripheral controllers. Further, the peripheral controller may control one or more specialized “peripheral devices” (e.g., effects lights, back lights, bar code detectors, tampering sensors, position sensors, sound devices, electro-luminescent devices and stepper motors, etc. that perform specific functions of the slot reel peripheral).

One aspect that McGlone provides is a slot reel peripheral that generally can be characterized as including (1) a drive mechanism, (2) a single slot reel that may be moved from position to position by the drive mechanism, (3) a peripheral controller that directly controls the drive mechanism and (4) a peripheral communication connection for connecting the peripheral controller to a master gaming controller.

Similarly, Published U.S. Patent Application 2001/0036866 (Syckdale et al.) describes a gaming machine comprising: a master gaming controller that controls one or more games played on the gaming machine; and a plurality of gaming peripherals coupled to the gaming machine and in communication with the master gaming controller, each of the plurality of gaming peripherals comprising a standard peripheral communications connection, one or more peripheral devices specific to each gaming peripheral, and a peripheral controller designed or configured to control the one or more peripheral devices, the peripheral controller including (i) a control microprocessor, separate from the master gaming controller, designed or configured to control communication with the master gaming controller over the peripheral connection, and (ii) a peripheral interface that directly connects to the one or more peripheral devices and is specific to the individual gaming peripheral.

The peripheral controller preferably includes (i) a control microprocessor that controls communication with the master gaming controller over the peripheral connection (the controller microprocessor is substantially similar in each gaming peripheral), and (ii) a peripheral interface that directly connects to one or more peripheral devices and is specific to the individual gaming peripheral.

In one embodiment, the gaming machine includes a motherboard with an acceptor for the master gaming controller and a hub containing a plurality of standard communications ports for connecting to the plurality of gaming peripherals. The acceptor is configured to allow the master gaming controller to be removed from the motherboard without requiring disconnection of the gaming peripherals from the hub. Further, the motherboard is configured to allow additional gaming peripherals to be connected to the master gaming controller without requiring that the motherboard be rewired. In preferred embodiments, the gaming machine is a mechanical slot machine, a video slot machine, a keno game, a lottery game, or a video poker game. One or more of the peripheral devices may be selected from the group consisting of lights, printers, coin hoppers, bill validators, ticket readers, card readers, key pads, button panels, display screens, speakers, information panels, motors, mass storage devices and solenoids. At least one of the standard communications ports may be a secure port, having a level of security exceeding that of other ports on the hub. The secure port is secured by one or more doors, locks, sensors, evidence tapes, or combinations thereof. Further, the master gaming controller may be configured to require that a specified gaming peripheral be connected only through the secure port. Also, the gaming machine may include a plurality of hubs, each containing a plurality of standard communications ports for connecting to the plurality of gaming peripherals, where one or more of the hubs is a secure hub, having a level of security exceeding that of one or more other hubs. The secure hub is secured by one or more doors, locks, sensors, evidence tapes, or combinations thereof. Further, the master gaming controller is configured to require that specified gaming peripherals be connected only through secure hubs.

Published U.S. Patent Application 2001/0187830 (Stockdale et al.) describes a gaming machine that generally can be characterized as including (1) a master gaming controller that controls one or more games played on the gaming machine, and (2) a plurality of gaming peripherals coupled to the gaming machine and in communication with the master gaming controller. The gaming peripheral should include (a) a standard peripheral communications connection, which may be identical in each gaming peripheral (b) one or more peripheral devices specific to the individual gaming peripheral and (c) a peripheral controller that controls the one or more peripheral devices. The peripheral controller preferably includes (i) a control microprocessor that controls communication with the master gaming controller over the peripheral connection (the controller microprocessor is substantially similar in each gaming peripheral), and (ii) a peripheral interface that directly connects to one or more peripheral devices and is specific to the individual gaming peripheral. In one embodiment, the gaming machine includes a motherboard with an acceptor for the master gaming controller and a hub containing a plurality of standard communications ports for connecting to the plurality of gaming peripherals. The acceptor is configured to allow the master gaming controller to be removed from the motherboard without requiring disconnection of the gaming peripherals from the hub. Further, the motherboard is configured to allow additional gaming peripherals to be connected to the master gaming controller without requiring that the motherboard be rewired.

U.S. Pat. No. 6,071,190 (Weiss) describes a gaming device security system which includes two processing areas linked together and communicating critical gaming functions via a security protocol wherein each transmitted gaming function includes a specific encrypted signature to be decoded and validated before being processed by either processing area. The two processing areas include a first processing area having a dynamic RAM and an open architecture design which is expandable without interfering or accessing critical gaming functions and a second “secure” processing area having a non-alterable memory for the storage of critical gaming functions therein.

Typically, on a live gaming table, a central gaming machine computer controls various combinations of devices. The features of a given device, including card reading, game status detection and the like are usually controlled by a “master gaming controller” in communication with the casino table gaming table monitoring equipment. For example to control payouts during a game, the master gaming controller might perform many different operations including electronically comparing player hands with a pre-programmed pay table of winning combinations and payouts, confirming that a side wager was made prior to paying out a side bet payout to a player, instructing a stepper motor on a card delivery system to access cards within the device, deliver cards to the dealer and then stop card movement/delivery at a certain position, verify that the correct number of cards are present in the shuffler, instructing lights on the table reel to go on and off in various patterns, or instructing a speaker connected to the table to emit various sound patterns, for example. For the master gaming controller to perform these operations, connections from the casino table monitoring equipment are wired directly into some type of electronic board (e.g., a “back plane” or “mother board”) containing the master gaming controller.

Casino Table Games (such as blackjack, poker, poker variants such as Let It Ride® poker, Three Card™ poker and Four-Card™ poker, baccarat, Casino War™ game, also require some security control, and more highly automated systems are being described in the literature and introduced to the marketplace. There are, for example, numerous U.S. Patents assigned to MindPlay LLC (e.g., U.S. Pat. Nos. 6,712,696; 6,688,979; 6,685,568; 6,663,490; 6,652,379; 6,638,161; 6,595,857; 6,579,181; 6,579,180; 6,533,662; 6,530,837; 6,530,836; 6,527,271; 6,520,857; 6,517,436; 6,517,435; and 6,460,848) that describe systems and components of systems that are used to more fully automate casino table card games, especially blackjack. These systems include card recognition devices, bet sensing devices (e.g., chip sensors and counters), software to evaluate the games as and after they are played, and the like. One feature of the MindPlay system is a central processor.

U.S. Pat. No. 5,803,808 (Strisower) describes a device to be utilized in live casino gaming that will count the number of “hands” (read “rounds”) of a given card game played per given period of time. The information is used by a database system within the casino to determine theoretical win/loss based upon historical and theoretical outcome data related to probability of winning/losing any given hand and then factoring in the number of hands (rounds) played. Preferably this device is polled by a database system to collect this information. In a preferred embodiment, the device could be utilized with an automatic player tracking and information management system. The automatic tracking and information management system (ATMS) automatically determines various player transactions associated with a device in a gaming establishment. The ATMS includes an automatic tracking and management unit (ATMU) which transmits and receives information between all gaming tables in all pit areas and the gaming establishment database system.

The ATMU provides for the interactive determination of various transactions within the pit area. Through the automatic tracking and management system the manual paper tracking, activities associated with the pit area are eliminated, thereby freeing pit personnel for other tasks. The device could also be generically connected to any tracking and information system through any standard serial interface.

Various U.S. Patents that include automation enhancing technology for casino table card games include U.S. Pat. Nos. 6,582,301; 6,299,536; 6,165,069; 6,117,012; 6,093,103; 6,039,650; 5,722,893; 5,605,334. As can be seen from these disclosures, the computing and component structures of gaming systems follows the traditional format of a main processor driving peripherals, and where one feature demands a significant amount of computing power, two processors may be added, with one processor still tending to be the dominant main processor sending commands to the peripherals. In known table systems, peripheral devices (such as a hand sensor, round counter or bet sensor) provide the signal and sends the signal to a gaming table processor and/or to a main processor. These signals are sometimes logged in with a time stamp for noting when it was received and/or logged in. The systems in gaming table operations tend to be structured in the same manner, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game. Examples of such systems include method, apparatus and article for verifying card games, such as playing card distribution as described in U.S. Pat. Nos. 6,638,161; 6,595,857; 6,579,181; 6,579,180; 6,533,275; 6,530,837; 6,530,836; 6,527,271; 6,520,857; 6,517,436; 6,517,535; and 6,460,848 (the Soltys' patents). Other gaming table systems that operate on the basis of a central programmer commanding peripheral devices (that may or may not have some processing capability of their own) include U.S. Pat. Nos. 6,299,536 and 6,039,650 (Hill); U.S. Pat. No. 5,779,546 (Meissner) which describes touch screens and player entry features at each player position, U.S. Pat. Nos. 6,093,103 and 6,117,012 (McCrea) which describes card sensing systems at each player location as well a card reading shoes; and U.S. Pat. No. 6,126,166 (Lorson) describing a card control and recognition system and method.

U.S. Pat. No. 6,629,894 (Purton, Dolphin Advanced Technologies, Ltd.) describes a card inspection device including a first loading area adapted to receive one or more decks of playing cards. A drive roller is located adjacent the loading area and positioned to impinge on a card if a card were present in the loading area. The loading area has an exit through which cards are urged, one at a time, by a feed roller. A transport path extends from the loading area exit to a card accumulation area. The transport path is further defined by two pairs of transport rollers, one roller of each pair above the transport path and one roller of each pair below the transport path. A camera is located between the two pairs of transport rollers, and a processor governs the operation of a digital camera and the rollers. A printer produces a record of the device's operation based on an output of the processor, and a portion of the transport path is illuminated by one or more blue LEDs. A printer is also provided as part of the system driven by a central computer.

Crown Casinos in Australia has recently provided a device that assists in counting rounds of play by using a card-sensing component on a table that responds to the blockage of ambient light into a hole and the forwarding of the sensed data to a central computer. The data is logged in as it is received in the central computer to indicate a time element associated with each piece of data received.

Disadvantages of the current casino table game architecture include at least the following. First, the number of types of motherboards needed to accommodate all of the potential combinations of gaming devices has become large. Second, the computational capability of the motherboard needed to drive all the devices has become large. Third, when devices are added to augment the features of the gaming machine or when devices are replaced for maintenance the steps necessary to rewire the device onto the motherboard and load the appropriate software onto the motherboard can be time consuming and require significant shutdown time for the gaming table. Accordingly, it would be desirable to provide casino gaming table architecture and components that are compatible with a standard communication protocol and/or connection system for installing or removing devices controlled by a local, central or other master gaming controller.

A casino table gaming peripheral that is compatible with a standard communication protocol and/or connection system may reduce the number of types and sophistication (expense) of motherboards that are needed for the casino table gaming machine and may reduce the amount of maintenance time when any electronic component is replaced. Further, it would be desirable to have the casino table gaming peripheral control some or all of its own functions rather than having all the functions controlled by the master gaming controller. This feature might reduce the load on the computational resources of the master gaming controller.

A concept of operative control among processing units should be appreciated to appreciate the performance of the present invention as well as to comprehend differences between the practice of the present invention and conventional processing apparatus used in the gaming industry. The most important concept is that most existing systems perform by a single main processor sending commands to peripherals to perform specific functions. Other systems divide the processing between master and servant processors. For purposes of discussion, the initial main emphasis of the description will be directed towards the performance of a casino table card game gaming apparatus. This emphasis is not intended to narrow the scope of the invention, but is rather intended to simplify the description.

The systems in live gaming table systems tend to be structured in the same manner as the slave master-formats of slot machine devices, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game.

Examples of such systems include method, apparatus and article for verifying card games, such as playing card distribution as described in U.S. Pat. Nos. 6,638,161; 6,595,857; 6,5,79,181; 6,579,180; 6,533,275; 6,530,837; 6,530,836; 6,527,271; 6,520,857; 6,517,436; 6,517,535; and 6,460,848 (the Soltys' patents). Other gaming table systems that operate on the basis of a central programmer commanding peripheral devices (that may or may not have some processing capability of their own) include U.S. Pat. Nos. 6,299,536 and 6,039,650 (Hill); U.S. Pat. No. 5,779,546 (Meissner) which describes touch screens and player entry features at each player position, U.S. Pat. Nos. 6,093,103 and 6,117,012 (McCrea) which describes card sensing systems at each player location as well a card reading shoes; and U.S. Pat. No. 6,126,166 (Lorson) describing a card control and recognition system and method. As can be seen, even where there is some processing intelligence distributed around a gaming table, the underlying operation of the system remains a central command and response structure, which both requires high component costs and limits the operation of the system. A gaming system with different architectural structure would be desirable if it could reduce costs and add flexibility to the system and enable ease of component replacement.

### SUMMARY OF THE INVENTION

The present invention is a method of collecting data at a gaming table and providing a local dedicated intelligence such as a G-Mod to read signals from the data collection device, date stamp and forward the data to an external database.

Multiple intelligent data collection modules acting as finite state machines are each communicatively interconnected with at least one of a shuffling apparatus (e.g., playing card shuffling or randomizing apparatus), a bet sensor and a “Semi-Smart” delivery shoe or card receiving shoe to collect data, date stamp the data and send it to a central data repository either directly or via a network. Although both direct connections between a dedicated processor such as a G-Mod or other microprocessor to an external database and a network connection to a database are both contemplated by the present invention, only the network example will be described in detail. The processing unit, referred to in this application in one example within the generic scope of the present disclosure as a “G-Mod” is a microprocessor with associated memory that is capable of being programmed. In another form, the G-Mod is a hard wired as a FPGA (field programmable gated array). The G-Mod performs data acquisition, date stamps and sends sensed data via a network such as an Ethernet to an external computer that contains a database. In some situations, the G-Mod temporarily stores data. In contrast to systems that provide an exclusive main computer to command all or most individual sensors and peripherals, in the presently described technology, the G-Mod's detect activity in the sensors and peripherals (i.e., data acquisition devices). The G-Mod's date stamp and broadcast the information over an Ethernet or another network to a central database. One preferred mode of communication is UDP but others such as TCP and TCP/IP are alternate communication protocols. In a preferred form of the invention, the G-Mod's broadcast information over a network but do not issue commands to other G-Mod's. Less powerful techniques (as compared to typical main processor systems used in gaming apparatus) may be distributed to monitor each peripheral using the proposed control architecture. The use of these separate intelligences for each peripheral eliminates the need to reprogram old modules as new modules are added, and allows the manufacturer to offer customized hardware and software packages capable of collecting only the information that the casino operator wants to collect.

Casino table card games can be provided with a wide variety of sensors. A number of sensors that are a part of the technical novelty of this disclosure is for detection of an event that indicates the number of hands played of a casino table card game. A sensor sensing hand count is read by the distributed intelligence table subcomponent (a G-Mod) that has a time/dating capability. The signal is time/date stamped (referred to herein as “Date Stamping” or “date stamping” for simplicity. The data may be temporarily stored in the memory of the G-Mod. The date stamped data is then transmitted generally through a network communication line to an external computer that contains database management software and a database interface. The data can be accessed by programs used to analyze the data, if needed. The database interface allows casino management to extract the data in a usable form. The collected data retains its date stamping at least through storage, analysis, data entry or other treatment of the data after transmission away from the table, and the date stamping is typically provided by the separate intelligence, although in some cases may or may not be provided by the sensor itself.

### BRIEF DESCRIPTION OF THE FIGURES

FIG. 1 shows a schematic of distributed architecture information flow in casino-type gaming machine.

FIG. 2 shows a flow diagram of distributed architecture information flow in a gaming table environment.

FIG. 3 shows a partial cutaway view of the end of a delivery chute in a semi-smart dealing shoe.

### DETAILED DESCRIPTION OF THE INVENTION

The present invention it's methods and apparatus for measuring rounds and/or hands of play on a gaming table, using one or more electromechanical, mechanical or processor controlled devices to collect the data is disclosed. The devices may be controlled centrally or may be controlled with the aid of distributed architecture, as described in co-pending applications, Ser. No. 10/880,410 and Ser. No. 10/880,408 both filed Jun. 28, 2004, the content of both applications which is hereby incorporated by reference.

It is to be understood that all of the devices that are described in this application are capable of sending signals directly to a central controller such as a table computer, and all devices can also send signals to a dedicated microprocessor that date stamps the signals and then in-turn sends the signals to a central processor or database.

The examples of devices that are described below send signals to G-Mod's that are dedicated microprocessors that receive and date stamp signals, then send data to a central database. The G-Mod's operate in a network environment and control the data collection activities at the gaming table without the need for a central controller. G-Mod's are capable of broadcasting information such as a state signal over the network, which causes other G-Mod's to react, without sending commands from one G-Mod to another.

The initiating event that occurs which becomes a basis for a signal indicating a number of hands in a round of play comes at least from one of four elements on a casino gaming table environment. Elements according to the described technology include at least 1) a playing card shuffling device, 2) at least one bet sensor, and 3) at least one card delivery or 4) card discard receiving device. As these devices may have multiple events occur during their use in a single round of play, the event selected for providing the signal or the initiation of the signal should be sufficiently unique during the operation of the element as to clearly indicate a round count event.

For example, in the use of an automatic playing card delivery tray or an automatic card shuffler, there are numerous events that may be repeated. With a delivery tray, removal of individual cards occurs repeatedly within a single round of play, and every card removal could not be used to indicate a hand. Similarly with a shuffler, —certain activities within the shuffler do not occur at the same frequency as the delivery of a hand. Examples of activities that do not correspond 1:1 with hand delivery include: separation of a first group of cards into separate sections, elevator movement, card movement from the first group of cards to be shuffled, rotation of a carousel or fan, ejection of cards from a first set of cards to be randomized, counting or identifying of cards, counting card totals, etc., and so particular events must be identified in the shuffler activity that would be used for hand counting event notification. There are numerous activities from which events could be selected. It is also possible to provide a dealer input system (e.g., button, panel, touch screen, voice activation, etc.), although this again brings dealer activity and dealer attention into the signal, while an automatic signal is preferred.

For each of the devices, non-limiting examples of the types of occurring events will be discussed to provide a basis of considering those events for selection or at least analysis of the many other occurring events from among which one or a combination of events may be programmed or selected to provide the hand counting and/or round counting in signal event.

Round Counting In A Shuffler

In a shuffling device, it may be desirable to count rounds as well as hands. An advantage to counting both is that the number of hands per round can also be determined. The information may also be associated in other ways. One simple way of determining a count of rounds and providing a signal that will be the event basis for sending a signal or command to send a signal could be a “Start Shuffling” signal. This is not merely an on/off switch event, but rather (in a batch shuffler), any action that initiates a beginning shuffling sequence for a full set of cards (e.g., one deck, multiple decks) to be shuffled. In certain shufflers, this signal is sent when a deck(s) is inserted is inserted into a card receiving area. The shuffler then automatically begins a complete shuffling sequence. In some shufflers there is an additional advantage to the selection of this internal shuffler signal as the round-counting starting event, and that is the fact that the actual dealing of a round of cards is allowed only when a first set of playing cards has been randomized and a second set of playing cards inserted into the shuffler. Therefore, there may be no lag in round counting as the system can be programmed to initiate a round count signal upon the first occurrence of the second set being inserted into the shuffler, and then every subsequent round count event will be the insertion of any next set of cards. The actual rounds dealt will then correspond more literally with the actual count provided.

Another event on certain formats of shufflers that can provide a sufficiently unique event as to provide a reliable round counting event is a batch shuffler where partial hands (in excess of single cards) or complete hands are provided to players or to players and dealers or to players and community sets of playing cards. A unique event in the round operation of such a shuffler would include a first hand being dealt to any player, a dealer hand being dealt, community cards being dealt, surplus cards being provided to the delivery tray, or combinations of these events. In the operation of the hand-providing shufflers, different designer choices may suggest the benefits of one event versus another, but with intelligent control and programming of the system, there should be numerous events from which to select the event that will trigger the round count signal from a shuffler. In some shuffler systems there are doors that are opened or closed for removal of randomized sets of playing cards or for insertion of unrandomized cards. The movement of these doors, especially where door movement is automatically performed by the shuffler apparatus, provides a good round counting event to trigger a signal. Events such as a jam signal could also be used to send a non-round count signal or subtract round count signal if a round count signal had been sent during that shuffling cycle.

Hands Played Sensing Using A Shuffler

After the round has been identified, the shuffler (having the capability of dispensing hands) automatically begins a sequence of hand dispensing. As a hand is removed from the discard tray, the next hand is delivered. A sensor in the tray may sense the removal of the hand and this signal may trigger the dispensing of the next hand. This process continues until the hands are extinguished, or until the dealer presses a button on the device that indicates no more hands are needed and that the machine should unload. The number of hands played could be measured by incrementing a meter when each new hand is removed from the tray.

Dealing procedures in most casinos (except for the game of Pai Gow and its variants) requires the dealer to press a button after the last hand of cards is dealt to the player and/or dealer. This event triggers the machine to unload the remaining cards. The processor in the shuffler has recorded the number of hands dealt in its memory (or sends a signal representative of the number of hands in the round) to the associated G-Mod and this signal is used to increment the number of hand dealt in the database.

In alternate embodiments, bet sensors are used at the table. One of the possible uses of bet present sensors is to determine a number of hands to be dealt from a shuffler. In one embodiment, information from the bet sensors is used to instruct the shuffler to deliver a specific number of hands of cards. “The number of hands” instruction could also be used to determine the number of hands per round in a game.

Other triggering events within the shuffler can also be used to track the number of hands dealt. For instance, in an ACE® shuffler, the structure disclosed in U.S. patent application Ser. No. 09/060,627, filed Apr. 15, 1998, now U.S. Pat. No. 6,149,154, (the content of which is incorporated by reference in its entirety), all hands are formed in a plurality of compartments, prior to the first hand being dispensed. The activation of the card unloading mechanism can be sensed and used to increment a hand counting algorithm. The dealer activation of the shuffler unloading command can stop the counting.

Round Counting In A Discard Rack

In an automatic card discard receiving rack, other distinct events could be programmed or designed to provide a unique round or hand counting signal. Where discard racks are used to verify a deck or set of cards (that is all playing cards placed into the discard rack are counted (to verify a total number of playing cards) or counted and read (to verify a specific set of a particular number of playing cards), the occurrence of a verified set signal, the combination of cards inserted with the absence of an alarm signal, and the like could be used to trigger the round count signal. In a discard rack with a card counter, the total number of cards returned from play could be used to determine how many hands of cards were played—at least in games where fixed numbers of cards are in a hand. In a continuous shuffler system used with a card discard rack, the insertion of any set or group of cards into the playing card discard rack could be an effective event to measure a round. This could be easily performed by the dealer waiting until all hands at the table have been played, with cards from intermediate events ending the play of individual hands (e.g., a player busting) being stored in an intermediate receiving area, and then when all cards (including dealer cards) have been collected, the insertion of all cards from that round inserted into the card receiver. In that case, the single event of placing a set of cards into the card receiver would uniquely trigger an accurate round counting event to provide the round count signal.

Hand Counting Using A Discard Rack

In a hand counting system, the activation of the reloading of previously played cards could activate an algorithm to count a number of cards returned to the shuffler. If a fixed number of cards are used in the play of a particular game (such as Let It Ride®, for example, the total card count can be divided by the number of cards per hand to arrive at a hand count. If the number of cards in each hand is variable, an output from another device, such as hand analysis software could estimate or determine the number of hands played for the number of cards returned. Preferably cards are read as they are dealt, as well as at the conclusion of play to arrive at an accurate determination of the number of hands played in a round.

Round Counting Using Bet Sensors

In the use of the bet sensor(s) to automatically provide a unique event signal that can be used to provide a signal regarding the count of a round of play, there are again options for providing the round count signal from a unique event performed by or on the sensors. In some sensor systems, there is a lockout mechanism performed by the dealer on bonus wagers (e.g., in Caribbean Stud® poker, Let It Ride® stud poker, etc.), so that when the lock-out step (preventing further wagers) is electronically or mechanically effected, a signal could be sent that a round has been played. When bet sensors are under the table, a change from “Bets Present” to “All Bets Removed” sensed by the sensors would be a unique event signaling the end of one round, and a signal would be sent. Again, the designer has to select an event that cannot be misinterpreted as anything other than a unique event during a round of play before sending a round count signal.

Use of Bet Sensors To Count Hands

The use of bet sensors is a desirable and accurate method of tracking a number of hands played on a live table game. A player may play two hands, but he must make two wagers in order to play them. By providing an electronic signal that indicates a wager has been placed, it is possible to obtain a 1:1 correspondence between hands played and the number of wagers placed.

Numerous prior art methods are available for sensing wagers, including optical object sensing, metallic object sensing, ultra sound, camera imaging, U.V. radiation measurement, radio frequency chip sensing and the like. Any of these devices can generate an output that can be sensed by a dedicated G-Mod, date stamped and sent via a network to a database to record that another hand was played. The hand count can be recorded in G-Mod memory, in database memory, or both.

Use Of A Semi-Smart Shoe To Count Rounds

In a Semi-Smart Dealing Shoe (which is defined herein), the unique event corresponding to a round of play may be pressing a button on the shoe, cessation of dealing from the shoe for an extended period, and rapid dealing from the shoe for a period of time with at least (for example, in blackjack) four cards being dealt in succession (indicating that at least one player hand and one dealer hand have been dealt, and not merely two cards being dealt as hits in a blackjack game.

Use Of A Semi-Smart Shoe To Count Hands

A semi-smart dealing shoe (i.e. a dealing shoe capable of sensing at least a number of cards removed from the shoe, and generating a signal that corresponds to the removal of a card) can also be used as a measure of hands counted, when combined with a card present sensor at the dealing station. A number of cards can be dealt out in the game of blackjack, representing an initial hand for each player. After a number of cards X are removed from the dealing shoe, the dealer puts his cards over the dealer sensor on the table, creating a signal that corresponds to the command “stop counting”. Then the number of hands can be determined by subtracting two (for the dealer's cards) and dividing the remainder by two (two cards per hand). The dealer could also cover the card present sensor with his first card. In this case the number of spots occupied would simply be the number of cards dealt (one card per hand) minus 1 (for the dealer's card). All of the mathematical treatment can be accomplished in the G-Mod's, or preferably in the distal database.

Although the method is described in terms of using a card present sensor in a dealing shoe, it is to be understood that there are several commercially available continuous shufflers that have integrally formed dealing shoes, such as Shuffle Master, Inc.'s KING® card shuffler, as described in U.S. Pat. No. 6,254,096, and the One-2-Six™ card shuffler, also marketed by Shuffle Master, Inc. and described in detail in U.S. Pat. No. 6,659,460. The content of both of these patents is hereby incorporated by reference. The present method may be practiced using this type of device instead of shoe, as long as the integral dealing shoe has at least card presence sensing capability.

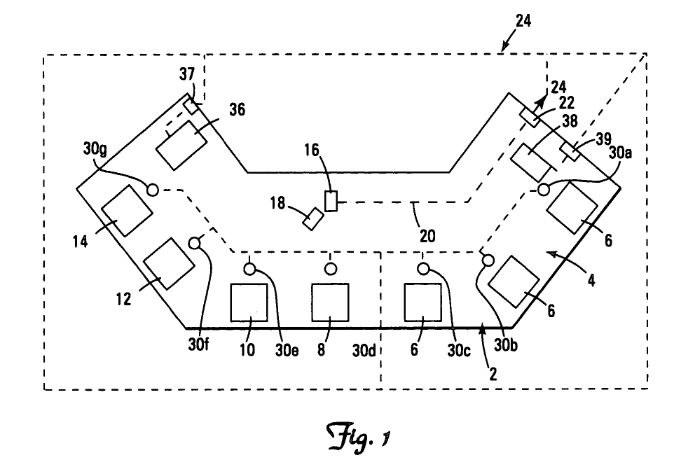

FIG. 1 shows a casino card gaming table 2. The table 2 has a surface 4 with seven player positions 6 (three positions labeled 6, and positions 8, 10, 12 and 14 thereon). A hand sensor 16 is provided for the dealer cards 18. The sensor 16 is connected by a communication system 20 (preferably a wire system, but RF or other wireless systems could be used) to a finite state machine or G-Mod 22 for the device 2. The finite state machine 22 is on a network communication line 24 to a data collector (not shown). Also shown are seven bet sensors 30a-g, a bet sensor G-Mod 31, a semi smart shoe 38, a shoe G-Mod 37, a discard rack 36 or receiving tray 38, receiving tray G-Mod 39 and a communication system 24 (which again may be wired, wireless, RF, infrared, etc.). The communication system is preferably a network. Just as explained below for the operation of the hand sensor 16, the unique round counting and hand counting events in any of the bet sensors 30, the semi smart shoe 38 or the discard tray 36 will enable or cause the round count signal to be sent, either to the G-Mod 24 or alternatively to a central processor or the like, as described herein. Bet sensor 30a is shown in communication with a communication with the sensor G-Mod 31.

In order to accomplish hand counting using the semi smart shoe 36 of FIG. 1, individual cards are counted out until the dealer covers the dealer card sensor 16 with his cards. A simple algorithm (previously described) allows a calculation of hands dealt in the round when the game is blackjack. Games using fixed numbers of cards (i.e. three and five card poker games) that are played against a dealer hand using a similar algorithm to determine the number of hands. Games played against each other or the house might require the dealer to place a marker over the sensor, or a timer in the shoe 36 could also be utilized to determine the last card dealt in the round.

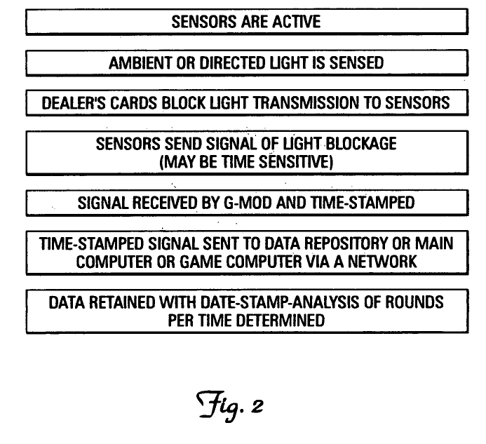

FIG. 2 shows a flow diagram of data transmission in a dealer round counting sensor in the system of FIG. 1. The components of a casino table gaming apparatus might include a coin acceptor, bill validator, a drop box capable of sensing the input of currency, ticket in/ticket out sensing/reading, lighting, video displays, card reading sensors, chip counters, security sensing, dealer input controls, player input controls, dealer identification card scanning, player tracking, round counting, hand counting, shuffle counting and the like. In the present technology described herein, a round counting system is also described, wherein the number of rounds of plays are determined (one round at a time) by a determination that a unique round counting event has been completed on the bet sensor(s), shuffler or discard rack, as described above.

The Semi-Smart Dealing Shoe is a novel concept in which the dealing shoe is designed to be used in a standard live casino table card game, and the cards are monitored as they leave the shoe. In one example of a semi-smart shoe is that there are multiple sensors (e.g., at least two sensors) present in the delivery area from the shoe and these sensors accurately indicate the passage of cards. This has been found to be a significant advantage over previous single sensor constructions that have proven to be less reliable. The at least two sensors provide signals in at least one of two sequences to indicate that a card has been removed from the shoe. In previous single sensor constructions, hand movement or other physical events, such as a rolling chip falling over a sensor, have created false card removal signals that disrupt the record keeping or card identification or hand control and monitoring systems that are associated with the more intelligent (computer monitored and analyzed) gaming systems that are in use and being advanced in the gaming industry.

The sequence of signals provided by the at least two sensors must be able to provide a signal sequence that identifies at least that 1) a card has been moved partway down the delivery chute of the dealing shoe and covers a first at least one sensor, but does not cover a second at least one sensor, 2) that a card has been moved entirely down to the bottom of the chute of the dealing shoe and covers at least two sensors, and 3) that a card has advanced such that it covers only one, but not two sensors. By requiring this set of parameters to be met in the sensing of the position of playing cards that have been moved from the dealing shoe, a positive and definite indication of card removal is provided, and that it would likely take intentional activity to cause a faulty signal of card removal to occur.

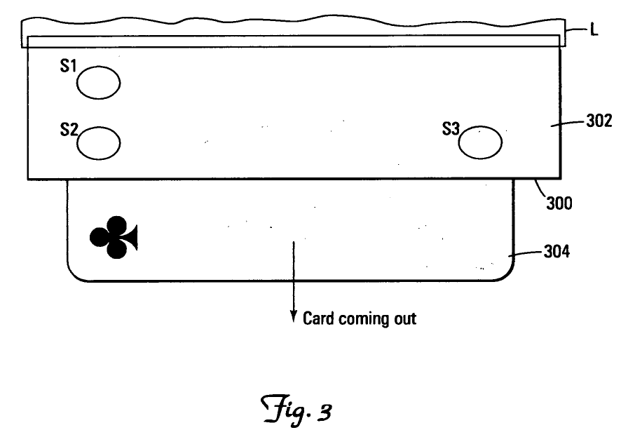

FIG. 3 shows a partial cutaway view of the end 300 from the bottom of a delivery chute 302 of a semi-smart dealing shoe (not shown in its entirety), with a card 304 being removed. The card 304 is actually being removed face down, so that the indicia of rank and suit cannot be viewed. The bottom of the sensors S1, S2 and S3 are shown, while the actual sensing portion of the sensors themselves would be on the other side of the chute 302 facing the cards so as to sense the position of cards as they are on the delivery face of the chute 302. The sensors S1, S2 and S3 are shown in an array of one inward sensor and two parallel (to the end 300 of the chute 302) sensors. The system may also perform with two first sensors (parallel to the position shown for S1) and one sensor in a position located similarly to that of S2 and S3 in FIG. 3. The sequence of signals required for performance of a signal (e.g., active signal, command signal or state signal) indicative of a card having been delivered from the dealing shoe would be, for the exact arrangement shown in FIG. 3, that shown in the table below:

| | SENSOR | | |
|---|---|---|---|
| STATE | S1 | SENSOR S2 | SENSOR S3 |
| NO ACTIVITY | OFF | OFF | OFF |
| INITIAL MOVE | ON | OFF | OFF |
| NEXT MOVE | ON | ON | ON |
| NEXT MOVE | OFF | ON | ON |
| CARD OUT | OFF | OFF | OFF |

The NO ACTIVITY state means only that no card is being dealt at that time and that all sensors are clear of obstruction (e.g., not blocked from light or not reflecting light back to sensor).

In an alternate embodiment, only sensors S1, S2 are present. The following sequence of sensor activity would establish that a card had moved past the sensor:

| STATE | SENSOR S1 | SENSOR S2 |
|---|---|---|
| NO ACTIVITY | OFF | OFF |
| INITIAL MOVE | ON | OFF |
| NEXT MOVE | ON | ON |
| NEXT MOVE | OFF | ON |
| CARD OUT | OFF | OFF |

Again, OFF means that the particular sensor is unblocked or is not reflecting light back to the sensor, and ON indicates that the sensor is blocked or that a card is reflecting light back to the sensor.

As demonstrated above, it is possible to use only two sensors at the two different levels within the chute for sensing card presence. In FIG. 3, for example, if only sensors S1 and S2 were present, it might be easier for a single event (e.g., dealer's hand movements or chip falling) to cause a misreading. If, for whatever reason, only two sensors were desired, it would be an improvement over a single sensor to have the two sensors in the positions shown for sensors S1 and S3 or in positions S1 and S2 to provide a better ability to indicate different states or positions of cards as the delivery of a card from the chute progresses.

The sensors can provide their signals to a G-Mod as described elsewhere herein that receive the signal and forward the signals, with or without date stamping from the semi-smart delivery shoe.

Any format or component may be used for the sensor that can indicate the presence of the card above or adjacent to the sensor. An optical sensor is the least expensive. The optical sensor may operate by receiving ambient (background or room) light to indicate that it is unblocked (OFF, no card over or adjacent to the sensor), or may emit light and indicate a blocking card (ON) by reflection of the emitted light back into a sensing element that along with the emitting element, is part of the sensor. With specially coated cards, magnetic sensors, metal detecting sensors, or the like could also be used.

In the practice of the present invention, communication to a data collection system with at least some peripherals is performed by general broadcast communication of game status (which may also be referred to as generated information or data) over a table-specific network, from more than one distributed intelligence source within the system, each of which is associated with at least one peripheral. Each distributed intelligence (a local processor) sends its own the game status communication over the network, but not send commands to the other G-Mod's. Each local processor (hereinafter G-Mod) is capable of sending date stamped information to a database where the information is stored and can be accessed by the same computer that holds the database or by another external computer. Each G-Mod is also capable of sending and receiving signals representative of a state, and can change state in response to signals received. It is a significant advancement in the art that information may be generally sent (essentially at the same time as a single, generally dispersed signal) over a network from multiple distributed intelligences.

For example, in the description given above for the insertion of a coin into the coin acceptor, when a coin is inserted in the system of the invention, the data is time stamped and send via an Ethernet network to a database collection system. As other G-Mod monitored activities occur, additional information is transmitted to the data collection system, independent of when/where other data is being collected and transmitted.

In one form of the invention, the state of each G-Mod is broadcasted over a network that contains all of the sensors and G-Mod's associated with one gaming table. As the state of one G-Mod changes, the broadcasted state signal may cause the states of other G-Mod's to change, and each G-Mod independently transmits information to the central data collection point.

One conceptual way of visualizing or understanding a method of implementing an intelligence system for the operation of a gaming system according to the present invention is as decomposing the tasks of previous constrained (central processor commanded) systems into orthogonal or unrelated sensing events running on independent processors. The term “orthogonal” for purposes of this disclosure means no commonality in function. The provision of orthogonal or independent intelligence functionality and individual performance capability allows the various system components to operate independently, and timely transfer the date stamped data to a database for further processing. Such a system functions more efficiently because there is no central processor prioritizing the execution of functions.

As noted above, there are many different elements of the gaming system that can be considered as peripherals. Some more important examples of table-game related peripherals include: bet presence, bet recognition, bet separation, card identification, card tracking, player tracking and employee tracking. Other components might include (in addition to those described above) multimedia processing, stepper motor control, random number generation, I/O detection and response, audio signals, video signals, currency handling, coin acceptors, bill acceptors, paperless transactions, ticket-in and ticket-out crediting, security systems, player accounting functions, door locks, signal lighting (change/assistance), player input (e.g., button controls, joy sticks, touch screens, etc.) and any other functions that my be provided on the gaming apparatus.

The units (which may be elsewhere referred to herein as gaming modules or G-Mod's) are operated substantially independently of each other, although some interdependencies could exist. In the event of interdependencies, they are not subject to the classic control model but operate by finite state machine changes that are broadcast and then react with intelligence. For purposes of this disclosure, the term “finite state machine” is a theoretical device used to describe the evolution of an object's condition based on its current state (or condition) and outside influences. The present state of an object, its history, and the forces acting upon it can be analyzed to determine the future state of an object. Each state then may have a “behavior” associated with it. An FSM is a very efficient way to model sequencing circuits. Ultimately the game is nothing more than a complex sequencing unit, branched as appropriate for the game function. All finite state machines can be implemented as hardware logic circuits, software running on a processor or combinations of the two.

In a preferred form of the invention, the data stamped data is broadcasted over an Ethernet specific to the table game, and that the data in this format is collected and recorded by the central data repository.

For example, a blackjack gaming table can be equipped with any of the above-identified systems to accomplish hand and/or round counting. The information on the unique round and hand counting events is information that can be used in combination with other date to deduce the number of cards dealt in a given round of play, rates of play, dealer efficiency, etc. If there are bet present sensors (and associated G-Mod(s)) for the bet sensors, the number of hands played per round of play can be determined. The modules may communicate with one-another to send date stamped bundles of information to the database, or may allow the state of one module to influence the operation of another module.

Each G-mod is collecting, date stamping and transmitting data as the data is collected from the table to a central database, but the G-Mod's are not sending commands to other G-Mod's. The database does not issue commands to the G-Mod's, except to reset, reboot and send and receive configuration information. In effect, each G-Mod is a freestanding microprocessor that runs independently of the any other intelligence, except that it receives limited operational information from the database computer.

A card swipe module could be added to the table system, with an associated G-Mod. This G-Mod could not only transmit time-stamped data to the data repository, but could also transmit player I.D. information to the player tracking system residing in the casino computer system.

One or more sensors could sense information transmitted through an output data port of a shuffler, for example, or a keypad control used to issue commands to a shuffler. The shuffler could have it's own G-Mod and is capable of transmitting date stamped information such as number of cards per hand, number of hands per hour, number of cards dispensed per unit time, number of cards re-fed into a continuous shuffler per unit of time, number of promotional cards dispensed per unit of time, etc. At the same time, another indicator attached to a G-Mod could transmit data stamped data about bonus awards granted at a certain time, and the like. This information could be collected in a central database. Alternatively, the processor internal to the shuffler could operate as a G-Mod.

A bet interface module could also be provided. Known collection techniques for wagering data include optical and metal detection type bet present sensors for fixed bets, and camera imaging, radio frequency/identification technology, bar code scanning, scene digitizing, laser scanning, magnetic strip reading and the like for measuring the amount of the bet, as well as the presence of the bet. Outputs from these measurement devices are fed through a dedicated G-Mod and the data is date stamped and delivered to the central data depository.

Another possible G-Mod controls a card reading camera, chip reading camera or other sensing device with similar functionality (reading rank and suit of a card, or just rank) located in the card shuffler, the dealing shoe, the discard tray, above the table or combinations of the above. Information about the specific cards dealt to each player could be obtained from the database by first feeding date-stamped information about cards dealt and returned into the database via the Ethernet.

In one form of the invention, the G-Mod sends date-stamped information to the database and an algorithm residing in the same computer or separate computer uses this information as well as round counting and betting information to determine the composition of a hand of blackjack, for example.

Another G-Mod is in communication with an identification (i.d.) system for tracking the movement of employees in and out of the pit, or more preferably when the dealers arrive at and leave the table. This information is collected and reported by the dealer G-Mod into the database, and then reports can be generated that combine this information with rounds of play per hour to determine which dealers deal the most hands in a given period of time.

In a roulette application, a sensor and associated G-Mod can record the number of spins of the wheel in a unit of time, for example. This information could be associated with the player swipe card information from another G-Mod by merely comparing the time stamping of the data to determine how long a particular player stayed at a table.

It is important to note that in a preferred form of the invention, all of the G-Mod's are in communication with the same database. Also, data repository does not issue commands to the G-Mod's, with the exception of requesting configuration data and resetting/rebooting the G-Mod's. The central database merely organizes the data in a manner that allows for easy access by external computers or another application program residing on the same computer as the database. In this respect, the G-Mod's are self-executing and do not require central intelligence to perform their individual functions. The data may be analyzed and used to make decisions about awarding redeemable points and free rooms to players, etc., scheduling pit labor, promoting pit personnel, closing and opening tables, determining optimal betting limits for given periods of time and other important managerial functions.

Each G-Mod may be in data communication with an interface device such as one or more specialized circuit boards to allow the data from multiple G-Mod's to be fed into a standard port of the computer that serves as the data repository. Also, multiple sensing modules may be fed into a single G-Mod if the particular G-Mod has the capacity to process the extra information.

A software interface can be provided to directly access data in the data repository and to manipulate and organize the data so that it can be outputted onto a display, written report or formed into a data stream so that the data can be further manipulated. In one example of a software interface program, the operator can obtain reports of rounds of play per hour per actual table, per pit, or per property, as determined by the user.

The information in the form of a data stream may be further analyzed. In one example, the data is fed into a host computer or can be analyzed in the same computer system where the database and interface resides or on a host computer. For example, the data from one or more of the round counting module, the shoe sensor, the card swipe, card reading module, the shuffler data port sensor, and the bet interfaces can be used to create a report of rounds played per unit of time, the number of players at the table per unit of time, the number of hands played at each round, the maximum bet per player in a given unit of time, the average bet per player in a unit of time, the number of shuffles per unit of time, the number of cards removed from and placed into the shuffler in a unit of time, hand composition and other information considered important to the casino manager.

Because all of the G-Mod's work independently, the casino operator can choose the modules and resulting data that is most important to them for a given environment, and only purchase those modules. For example, one casino might want to reconstruct individual hands, track betting and associate the information with a particular player on a high stakes table, while tracking only rounds and the identification of the employees on low-stakes games.

By using a modular approach to intelligent data collection, only the equipment and reports that are wanted can be provided at the lowest possible cost. Since none of the G-Mod's are issuing direct commands to one-another, it is not necessary to rewrite any code when additional modules are added.

Applicants have discovered that in centralized control systems, there are potential inaccuracies in data that are transmitted prior to date/time stamping. When signals are stamped in by the main computer, this is merely indicative of when the signal arrived. Also by providing the stamping function at the receipt site (such as the main processor, or central gaming location), the information is more easily subject to manipulation or change by an operator. Also, when there is a line breakdown (e.g., some casinos may still use telephone line connections which can be busy or interrupted, or the communication system to the main computer breaks down), the accuracy of the stamping is adversely affected. The value of the data decreases in some necessary transactions and casino oversight if the time data is inaccurate. A gaming system with different architectural structure and informational structure would be desirable if it could reduce these issues.

Among the features of technology described herein are a casino table card gaming system comprising: at least one gaming table (preferably a casino playing card table); at least one device on or proximate (proximate requires a communication link to the table for purposes of playing the game and transmitting information about the play of the game, such as a shuffler, bet detector, discard rack, playing card delivery shoe, position display in Pai Gow poker, and the like) to the gaming table that provides a signal that is indicative of a single round of play in the table card game system. The device is preferably selected from the group consisting of at least one bet sensor, a playing card shuffler, an intelligent playing card delivery shoe (by intelligent it meant only that it is capable of sending a signal relating to an event that is performed on the delivery shoe, such as how many cards dealt, cessation of cards dealt, round completed, etc.) and an intelligent discard rack (again, intelligence requires only that signals be capable of being sent with respect to events that occur on the rack) that senses activity that causes a signal to originate in the device and wherein an intelligent data collection module senses from that signal changes in output from the at least one device, the intelligent module acting as a finite state machine capable of date stamping the data and transmitting the date stamped data to a database over a network. Information transmission may be by any communicating link, such as the signal being sent from the device by an RFID circuit, Ethernet or hard wire link. The network communication method may be selected from the group comprising UDP and TCP, or any other available or convenient standard. The device is designed to provide a signal that has been selected as indication of an event that is a unique event in the operation of the device within a round of play of the card game. The intelligent data collection module may comprise a chipboard. The data collection module may or may not store signals or data contained in the signals after date stamping and forwarding the signals. The date stamped signals are received by a central database that organizes data relating to counting of rounds and a rate of rounds for at least one of a table and a dealer. Among unique events from which a signal is created or enabled could be, by way of non-limiting examples, sensing at least one of: cards dealt, hands dealt, all cards removed from the table, number of positions were bets have been placed, the presence and absence of a wager, cards returned to a discard rack, and a set of cards returned to a shuffler.

Another aspect of the present technology is a method of collecting data on a casino gaming table comprising: providing at least one device that performs at least one activity that is unique within a single round of play of a casino table card game; providing at least one intelligent controller dedicated to collecting information from at least one device; the intelligent controller receiving a signal relating to the at least one unique activity from the at least one device; the intelligent controller date and/or time stamping data collected from the at least one sensor; the intelligent controller broadcasting the date and/or time stamped data over a network; and recording the broadcasted information in a database. The database may receive date stamped signals over a period of time and the data is used by an external processor to compute a number of rounds played over a period of time, the time being based upon use of the date stamping received. The original signal from the device may or may not contain an indication of date or time thereon.

Another aspect of technology described herein may be a hardware component on a casino card table that senses signals from a device on a gaming table that performs at least one activity during each round of play of a card game that can indicate that a single round of play of a card game is or has been played, wherein the hardware component adds time and or date stamps information to the signals, and forwards the time stamped signal to a database, via a network. The component may be constructed so that it can or cannot store time stamped signals after forwarding the time stamped signals.

There are many different elements of the gaming system that can be considered as peripherals. Some more important examples of table-game related peripherals include: bet presence, bet recognition, bet separation, card identification, card tracking, player tracking and employee tracking. Another listing of these components would include (in addition to those described above) are multimedia processing, stepper motor control, random number generation, card reading, hand reading (ranking), player strategy review/analysis, I/O detection and response, audio signals, video signals, currency handling, coin acceptors, bill acceptors, paperless transactions, ticket-in and ticket-out crediting, security systems, player accounting functions, door locks, player input (e.g., button controls, joy sticks, touch screens, service calls, etc.) and any other functions that my be provided on the table gaming apparatus.

As noted earlier, round counting is one service or data component that can be important to a table. For example, round completion can be important for evaluating rates of play at tables, player rate performance, dealer rate performance, and even disputes over time of completion of hands at different tables or different casinos where priority might be an issue (as in competitive events or qualifying events).

Round counting requires some form of signal generation at a table that is indicative of approximate completion of a round and preferably absolute completion of a round. This can be done in a number of ways for signal generation as noted above, and single sources of data can be provided or multiple sources of round counting event signals (such as combinations of those described above or additional round counting signals such as dealer initiated signals) can be provided to enable redundancy and a higher level of confidence in the information on round counting. For example, video cameras can be placed to observe the dealer's hand. When the motions of a dealer or the dealer's cards indicate that the dealer's cards have been removed from the playing area, a signal is sent “round completed” or “dealer's hand removed” or some functional equivalent. A sensor can be placed on the table over which the dealer's cards are placed. It is preferred that this sensor not be as movement limiting as the sensor in U.S. Pat. No. 5,803,808, where cards appear to have to be specifically fitted into at least a right angle abutment with a card reading ability. Upright extensions on the card table can interfere with card movement, can interfere with chip movement, can cause accidental disclosure of cards, and are generally undesirable. A sensing system with a relatively flat or slightly indented or slightly raised surface is more desirable. The system could comprise a transparent or translucent panel approximately flush with the table surface that allows light (e.g., ambient light or specially directed wavelengths of light for which a sensor is particularly sensitive) to pass to a sensor. The absence of light in the sensor for a predetermined period of time and/or intervals of time can be the original signals themselves, which are interpreted by an intermediary intelligence on the table that has the time sensing capability for evaluating the signal. The original signals are then time stamped before being forwarded to the central database and can be analyzed by accessing the collected data.

Particularly in games where batch shuffling is used, such as poker or even single deck blackjack, the signal could also be originated by cards being placed in a shuffler and a shuffling process initiated, the shuffler sending a start-shuffling signal to the date stamping component on the table. The dealer could even activate or press a button provided on the table, but this would tend to leave the results under the control of the dealer, which could be manipulated by the dealer to improve results on dealer play, or could suffer from forgetfulness.

The application of this technology to gaming tables follows similar architecture and application of design and performance. Gaming tables would include typical casino tables such as those used for blackjack (Twenty-One), baccarat, roulette, poker, poker variants (Let It Ride® poker, Three-Card Poker® game, Caribbean Stud® poker, etc.), craps, and the like. These latter systems, unless they are completely electronic without any physical implementation (such as physical playing cards, dice, spinning wheel, drop ball, etc.) will need sensing and/or reading equipment (e.g., card reading for suits and/or rank, bet reading sensors, ball position sensors, dice reading sensors, player card readers, dealer input sensors, player input systems, and the like. These would be the peripherals in the table systems. Also, newer capabilities are enabled such as moisture detection (e.g., for spilled drinks), smoke detection, infrared ink detection (to avoid card marking), shuffler operation, dealer shoe operation, discard rack operation, jackpot meters, side bet detectors, and the like.

1. A casino table card gaming system comprising:
at least one gaming table;
at least one device on or proximate to the gaming table that provides a signal that is indicative of at least one of a single round of play, and at least one hand played in the table card game system, the device selected from the group consisting of a) at least one bet sensor, b) a playing card shuffler, c) a playing card delivery shoe that indicates a sequence of playing card positions for each playing card delivered from the playing card delivery shoe, and d) an intelligent discard rack that senses activity that causes a signal to originate in the device, and
at least one intelligent data collection module that senses from that signal changes in output from the at least one device, the intelligent module acting as a finite state machine capable of date stamping the data and transmitting the date stamped data to a database.

2. The system of claim 1 wherein the device is a playing card shuffling device.

3. The system of claim 1 wherein the device is a bet sensor.

4. The system of claim 1 wherein the device is the playing card delivery shoe.

5. The system of claim 1 wherein the signal from the device is sent by an RF circuit.

6. The system of claim 1 wherein the device is an intelligent discard rack.

7. The system of claim 1 wherein the signal from the device is sent by hard wire connection.

8. The system of claim 1 wherein the signal is sent over a network.

9. The system of claim 1 wherein the device is designed to provide a signal that has been selected as indication of an event that is a unique event in the operation of the device within a round of play of the card game.

10. The system of claim 1 wherein the intelligent data collection module comprises a chipboard.

11. The system of claim 1 wherein the data collection module does not store signals or data contained in the signals after date stamping and forwarding the signals.

12. The system of claim 1, wherein an event that triggers a signal is an event that occurs once per hand of cards dispensed.

13. The system of claim 9 wherein the intelligent data collection module does not store signals.

14. The system of claim 10 wherein the intelligent data collection module does not store signals.

15. The system of claim 2 wherein the shuffler provides individual hands or partial hands of playing cards to be manually withdrawn from the shuffler by a dealer.

16. The system of claim 1 wherein date stamped signals are received by a central database that organizes data relating to counting of rounds and a rate of rounds for at least one of a table and a dealer.

17. The system of claim 8 wherein the collected data is transmitted via an Ethernet.

18. The system of claim 8 wherein the network communication method is selected from the group comprising UDP and TCP.

19. The system of claim 1, wherein the device is capable of sensing at least one of: cards dealt, hands dealt, all cards removed from the table, number of positions where bets have been placed, the presence and absence of a wager, cards returned to a discard rack, and a set of cards returned to a shuffler.

20. A method of collecting data on a casino gaming table comprising:
providing at least one device that performs at least one activity that is unique within a single round of play of a casino table card game;
providing at least one intelligent controller dedicated to collecting information from at least one device;
the intelligent controller receiving a signal relating to the at least one unique activity from the at least one device;
the intelligent controller date and/or time stamping data collected from the at least one sensor;
the intelligent controller broadcasting the date and/or time stamped data over a network; and
recording the broadcasted information in a database.

21. The method of claim 20 wherein the database receives date stamped signals over a period of time and the data is used by an external processor to compute a number of rounds played over a period of time, the time being based upon use of the date stamping received.

22. The method of claim 20 wherein the original signal from the device contains no indication of date or time thereon.

23. The method of claim 20 wherein the signal is provided by a playing card shuffling device.

24. The method of claim 20 wherein the signal is provided by at least one bet detector.

25. The method of claim 20 wherein the signal is provided by a playing card delivery tray.

26. A hardware component on a casino card table that senses signals from a device on a gaming table that performs at least one activity during each round of play of a card game that can indicate that a single round of play of a card game is or has been played, wherein the hardware component adds time and or date stamps information to the signals, and forwards the time stamped signal to a database, via a network.

27. The component of claim 26 wherein the component is constructed so that it cannot store time stamped signals after forwarding the time stamped signals.

28. The system of claim 4 wherein the playing card delivery shoe comprises at least two sensors on a delivery chute of the playing card delivery shoe, the sensors sensing the presence or absence of a playing card.

29. The system of claim 4 wherein the playing card delivery shoe comprises at least two sensors on a delivery chute of the playing card delivery shoe, the sensors sensing a sequence of the presence or absence of a playing card.

30. The system of claim 29 wherein the at least three sensors on the delivery chute are distributed at least two different distances from an outermost end of the delivery chute.

31. The system of claim 30 wherein one of the at least three sensors is located farther from the outermost end of the delivery chute than two of the at least three sensors which are located nearer to the outermost end of the delivery chute.

32. The system of claim 31 wherein the two of the at least three sensors which are located nearer to the outermost end of the delivery chute are approximately equidistant from the outermost end of the delivery chute.

33. The system of claim 28 wherein when the one of the at least two sensors is covered by a playing card, at least one of the at least two sensors is not covered by the playing card.

34. The system of claim 31 wherein when the one of the at least three sensors is covered by a playing card, at least two of the two of the at least three sensors is not covered by the playing card.

35. The system of claim 29 wherein the at least three sensors on the delivery chute are distributed at least two different distances from an outermost end of the delivery chute, and wherein two of the at least three sensors is located farther from the outermost end of the delivery chute than one of the at least three sensors which is located nearer to the outermost end of the delivery chute.

36. The system of claim 35 wherein the two of the at least three sensors which are located farther from the outermost end of the delivery chute are approximately equidistant from the outermost end of the delivery chute.

37. The system of claim 28 wherein the sensors send state signals when the sensors sense the presence or absence of a playing card.

38. The system of claim 28 wherein the sensors send state signals when the sensors sense the presence or absence of a playing card.

39. A playing card delivery shoe that indicates a sequence of playing card positions for each playing card delivered from the playing card delivery shoe, wherein the playing card delivery shoe comprises at least two sensors on a delivery chute of the playing card delivery shoe, the at least two sensors sensing the presence or absence of a playing card.

40. The playing card delivery shoe of claim 39 wherein the playing card delivery shoe comprises at least three sensors on a delivery chute of the playing card delivery shoe, the at least three sensors sensing the presence or absence of a playing card.

41. The device of claim 1, wherein the intelligent module is a G-Mod.

42. The method of claim 20, wherein the intelligent controller is a G-Mod.

43. The device of claim 26, wherein the hardware component is a G-Mod.

44. The apparatus of claim 39, and further comprising a G-Mod for date stamping signals received from the sensors and transmits the date stamped signals via a network to a database.
